(19) United States
(12) Patent Application Publication
(10) Pub. No.: US 2007/0224385 A1
(43) Pub. Date: Sep. 27, 2007

(54) WAVELENGTH SELECTIVE DIELECTRIC FILTER AND ITS APPLICATION TO OPTICAL DISKS

(75) Inventor: Martin Dubs, Maienfeld (CH)

Correspondence Address: PEARNE & GORDON LLP, 1801 EAST 9TH STREET, SUITE 1200, CLEVELAND, OH, 44114-3108, US

(73) Assignee: OC OERLIKON BALZERS AG, Balzers (LI)

(21) Appl. No.: 11/753,083

(22) Filed: May 24, 2007

Related U.S. Application Data
(63) Continuation-in-part of application No. 11/456,131, filed on Jul. 7, 2006.
(60) Provisional application No. 60/697,804, filed on Jul. 8, 2005.
(60) Provisional application No. 60/803,044, filed on May 24, 2006.

(51) Int. Cl. B32B 3/02

(52) U.S. Cl. 428/64.4

(57) ABSTRACT

An optical storage medium having at least two information layers is provided, wherein a first information layer is in the form of a dichroic filter that is reflective at a first selected wavelength and transmissive at a second selected wavelength. The dichroic filter can consist of a single, non-metallic dielectric layer, such as a hydrogen-doped silicon layer. Total thickness of the dichroic filter is about or less than 100 nm. A second information layer that is reflective at the second wavelength is disposed behind and spaced from the dichroic filter. This construction permits a first incident light beam at the first wavelength to be reflected from the dichroic filter, to produce a first reflected beam carrying information recorded in that layer. A second incident light beam at the second wavelength can be transmitted through the dichroic filter and reflected from the second information layer to produce a second reflected beam that passes through the dichroic filter, carrying information recorded in the second information layer.

### CROSS-REFERENCE TO RELATED APPLICATIONS

This application claims the benefit of U.S. provisional application Ser. No. 60/803,044 filed May 24, 2006, and is a continuation-in-part of U.S. utility application Ser. No. 11/456,131 filed Jul. 7, 2006, which claims the benefit of U.S. provisional application Ser. No. 60/697,804 filed Jul. 8, 2005. The contents of the foregoing applications are incorporated herein by reference.

### BACKGROUND OF THE INVENTION

For data storage applications, dichroic films are used to store information in one layer (a first information layer formed by the dichroic film) that can be read by an incident laser beam at a first wavelength because the dichroic film is substantially reflective of light at that first wavelength. In multi-information layer applications, the dichroic film is substantially transmissive of light at a second wavelength, so that an incident laser beam at the second wavelength will be substantially transmitted through the dichroic layer to a second information layer located subjacent or beneath the dichroic film (first information layer). In this case the first information layer (dichroic film) has to have sufficient reflection at the first wavelength and high transmittance at the second wavelength. An existing application of this principle is the Super Audio CD hybrid disc, where the first layer reflects at 650 nm and transmits at 780 nm, so that both DVD and CD signals, respectively, can be read without interference or crosstalk from the other layer. In the future new data storage discs with higher capacity will come to the market, where at least one of the information layers will be designed to be read by a blue laser beam at a wavelength of 405 nm. As known in the art, this lower wavelength (and corresponding higher frequency) permits much greater information density to be stored on the information layer, resulting in higher data capacity for the layer. There will be a market for optical discs having multiple information layers wherein at least one is readable at 405 nm, and the other(s) is/are readable at 650 or 780 nm.

The reason one of the information layers (e.g. the dichroic layer mentioned above) needs to transmit the wavelength of light for reading the subjacent layer(s) is that multiple-data-layer optical discs should be readable from one side. There are some discs on the market that have to be turned over in the player to access the second side of the disc (i.e. a second information layer), or store one data format on one side and a second data format on the other side. This, however, prevents putting a label with the title and other visually readable information on one side of the disc. In addition it makes the insertion of the disc into the player ambiguous for the non-expert, who might be confused about which side contains what content.

Most of the film designs for dichroic filters mentioned above require multiple layers that result in a large thickness and generally high manufacturing cost.

An additional requirement for use in data storage applications is that these films are used to coat structured substrate surfaces containing information-carrying pits or grooves. That is, to produce a pre-recorded optical medium, a substrate often is first provided with the information-carrying pits and grooves in the appropriate sequence/orientation on the substrate surface. Then, the reflective material (dichroic film) capable to reflect the incident light so the information can be read is conformally coated over the pitted/grooved substrate surface. In order to retrieve the information from the coated surface, it is required that the pit shape is not changed by a significant amount with the addition of the reflecting or dichroic films. Otherwise, readout errors due to jitter or changing signal levels can occur. This limits the practical useful thickness of these coatings to less than about 100 nm for the high density formats (CD, DVD, HD DVD and blu ray formats). This in turn limits the number of dielectric layers—the known technologies use single metal layers or a single dielectric layer.

### SUMMARY OF THE INVENTION

An optical storage medium includes a first information layer and a second information layer. The first and second information layers are spaced apart from one another by an intermediate layer. The first information layer is reflective of light at a first selected wavelength and transmissive of light at a second selected wavelength. The second information layer is reflective of light at the second selected wavelength. The first information layer is provided as a dichroic filter having at least one dielectric layer but excluding metallic layers, wherein the total thickness of the dichroic filter is about or less than 100 nm.

A method of making an optical storage medium includes the steps of: a) providing a support layer having a first surface; and b) providing on that first surface a first information layer in the form of a dichroic filter. That dichroic filter includes a dielectric layer but no metallic layers, wherein the dichroic filter has a total thickness of about or less than 100 nm. The composition of the dielectric layer is selected so that the dichroic filter is reflective of light at a first selected wavelength, and transmissive of light at a second selected wavelength.

An optical storage medium includes a first information layer and a second information layer. The first and second information layers are spaced apart from one another by an intermediate layer. The first information layer is reflective of light at a first selected wavelength and transmissive of light at a second selected wavelength. The second information layer is reflective of light at the second selected wavelength. The first information layer is provided as a dichroic filter having a dielectric layer, wherein the total thickness of the dichroic filter is about or less than 100 nm.

### BRIEF DESCRIPTION OF DRAWINGS

FIG. 1 is a cross-sectional schematic view of an optical storage medium, such as a CD or DVD, having a dichroic filter layer as described herein as a first information layer. In FIG. 1, the dichroic filter layer 20 is composed of a metallic alloy layer (such as a silver alloy) 21 and a dielectric layer 22, which can be Si:H as hereinafter described. The dichroic filter 20 is sandwiched in between a substrate 10 and a second substrate 30. Also illustrated in FIG. 1 are an incident beam 7, a reflected beam 5 of light reflected from the dichroic filter layer 20, and a transmitted beam 6 of light that is transmitted through the dichroic filter 20.

FIG. 2 is a graph plotting calculated transmission and reflection versus wavelength data for a two-layer dichroic filter according to a design example described hereinbelow.

FIG. 3 is a graph plotting calculated transmission and reflection versus wavelength data for a three-layer dichroic filter according to a design example described hereinbelow.

FIGS. 4 and 5 illustrate two information layer designs of a storage medium utilizing a dichroic filter 20 as described herein. In these designs, the layer 30 is referred to as an intermediate layer (or bonding layer) because it is disposed intermediate the first information layer (dichroic filter 20) and the second information layer 40.

FIG. 6 is a graph plotting calculated transmission and reflection versus wavelength data for a single-layer dichroic filter consisting of a layer of Si:H having a thickness of 15 nm.

FIG. 7 is a graph plotting transmission and reflection versus wavelength data for the dichroic filter arrangement shown in FIG. 1, in the case where the silver alloy and Si:H layers have thickneses of 10 nm and 16 nm, respectively.

FIG. 8 illustrates an information layer design for a storage medium similar to FIG. 4, except that dichroic filter 120 consists of at least one dielectric layer, and excludes metallic layers.

FIG. 9 is a graph plotting calculated signal levels as a function of layer thickness for a single Si:H dielectric layer. Data is shown for three different wavelengths/standards: 405 nm, DVD9 650 nm, and DVD5 650 nm.

It is to be recognized that drawings in this application are not to scale.

### DETAILED DESCRIPTION OF PREFERRED EMBODIMENTS OF INVENTION

As used herein, when a range such as 5-25 (or 5 to 25) is given, this means preferably at least 5 and, separately and independently, preferably not more than 25. All percentages herein for the composition of a material, e.g. an alloy, are weight percents unless otherwise explicitly stated.

As used herein, a layer is considered reflective of a wavelength of incident light if the layer exhibits a sufficient percent reflectance at that wavelength to produce a reflected light beam of adequate intensity so a detector that detects the reflected beam can read a signal from the reflected beam, corresponding to the information recorded in the layer. A reflective layer as defined herein has the following minimum percent reflectance for the following wavelengths of incident light:

650 nm—18 percent reflectance; and

405 nm—18 percent reflectance.

Typically, a dichroic (semireflective) layer designed to reflect at one wavelength and transmit at another must reflect at least 18% at the wavelength intended to be reflected depending on the applicable standard, e.g., DVD, blu-ray or HD-DVD.

A layer is considered to be highly reflective at a wavelength if it has the following minimum percent reflectance for that wavelength as follows:

780 nm—60 percent reflectance;

650 nm—60 percent reflectance; and

405 nm—33 percent reflectance.

Also as used herein, a layer is considered to be transmissive of a wavelength of incident light if the layer transmits at least 40% of the incident light at that wavelength. A layer that transmits at least 50% of incident light is considered to be highly transmissive at that wavelength. It will be appreciated that under the foregoing definitions, it is possible for a layer to be both reflective (or highly reflective) and transmissive (or highly transmissive) of a particular wavelength of incident light, even though the simultaneous presence of both these properties in a single layer may not be a design criterion for that layer. As known in the art, whatever proportion of incident light that is neither reflected nor transmitted is absorbed by the layer.

Also as used herein, a read beam refers to a beam of light at a selected wavelength that is emitted from a source of that light and directed toward an optical storage medium, such as a CD or DVD. A signal beam refers to a beam of light that is reflected from a filter layer or other information layer of the optical storage medium after it exits the storage medium, including all the layers of that medium, on its way back to a detector for that beam. Unlike the percent reflectance described above, which refers to reflectance of a light beam incident on a specific layer, percent signal reflectance refers to the percentage of the read beam at a specified wavelength that is returned to the detector as the signal beam, after passing through all the layers of the storage medium in its path.

We define a filter or a filter layer as a layer or plurality of layers that is reflective of light at a first wavelength and transmissive of light at a second wavelength. When such a filter comprises a plurality of layers, then the resulting laminate structure, as a whole, is reflective at the first wavelength and transmissive at the second wavelength mentioned above. Preferably, the filter is highly reflective of light at the first wavelength, and highly transmissive of light at the second wavelength. The invention includes a filter based on using only non-metallic dielectric layers, and in one embodiment a single non-metallic dielectric layer, such as a silicon layer doped with hydrogen, referred to herein as Si:H, which is more fully described below. Alternatively, at least one thin metal layer with low absorption at the second wavelength mentioned above (for which the filter is transmissive, preferably highly transmissive) can be included in the filter, with at least one thin dielectric layer with high refractive index and low absorption at the second wavelength. This results in high transmittance at the second wavelength. The total thickness of the described filter structure is less than about 100 nm, and can be considerably less in the case of only a single non-metallic dielectric layer, such as less than 25 nm, e.g. 10-20 nm.

A suitable material for the dielectric layer, whether or not combined with a metallic described above, is a silicon film dielectric layer, with addition of hydrogen in the dielectric layer. The hydrogen content should be adjusted to saturate the dangling bonds of amorphous or polycrystalline deposited films. This can be produced economically by reactive sputtering of silicon with hydrogen, e.g. by adding hydrogen to the sputtering gas (typically argon). If a metallic layer is also to be included in the filter, then in a preferred embodiment that layer is a silver alloy layer, which also is preferably deposited by sputtering. Although a single-layer filter composed of a non-metallic dielectric layer may be most desirable from an economic standpoint, the addition of a metallic layer may produce improved performance, e.g. higher reflectance at the first wavelength and/or lower reflectance at the second wavelength mentioned above.

In one example of a filter, the filter exhibits high reflectance at 405 nm and high transmittance at 650 nm. But this can be modified by the skilled person to exhibit other desirable reflectance and transmittance characteristics, for example for other wavelengths, as needed. In the case where the filter has two layers (Si:H layer and silver alloy layer), the required thicknesses of the two layers to produce a filter having a transmission maximum near 650 nm are around 5 to 30 nm for each layer. Due to admittance matching, the transmittance of the combination of the two layers (metal and dielectric) is higher than the transmittance of either of the layers alone with the same thickness. It is important to choose a high refractive index for the dielectric layer (n≧2.0, preferably n around 3 to 4 for optimal results).

As is evident, the filter is not limited to one layer, although this would be the most economical filter. Improved performance (lower reflectance at 650 nm and/or higher reflectance at 405 nm) can be achieved by adding a metal layer. Additional improvement in performance may also be achieved by incorporating a second metal layer, which is achieved with improved admittance matching with near zero reflectance at the design wavelength (to be transmitted) and therefore optimum transmittance at that wavelength. For such a three-layer design, the high refractive index of the dielectric layer is less important for good performance, but it is important for a small total thickness.

A practical use of these filters is given below for some examples of optical discs with at least two layers of information, separated by a spacer layer as shown in the figures and hereafter described. The filter layer is located adjacent the incident surface of the optical storage medium, which is the surface to be placed adjacent the source of incident light that is used to read information from the filter layer (first information layer) and the subjacent information layer(s). The subjacent information layer(s) is/are either coated a) fully reflective for a two layer disc or the last information layer, or b) also dichroic or semitransparent (similar to the filter layer) in the case of more than two information layers. Examples of this structure include:
1. Application of a single-layer filter (e.g. Si:H layer) in a prerecorded disc with one information layer (the filter as described herein, a dichroic layer) readable at 405 nm (according to HD DVD or blu ray specifications) and a second information layer readable at 650 nm fulfilling DVD5 specifications. In this embodiment, the filter can be provided so that it is highly reflective of 405 nm incident light, and highly transmissive of 650 nm incident light, with the second information layer located subjacent the filter, and spaced therefrom by a spacer or intermediate (bonding) layer as known in the art and illustrated in the figures. The second information layer is preferably highly reflective at 650 nm.
2. Application of a two-layer filter in a prerecorded disc with one information layer readable at 405 nm (according to HD DVD or blu ray specifications) and one or two additional, subjacent information layers readable at 650 nm fulfilling DVD9 specifications. In the case of two subjacent information layers, the intermediate 650 nm information layer will be provided as a dichroic coating so that incident light can penetrate it to reach the remaining 650 nm information layer. Whereas, the last 650 nm information layer can be a fully reflective coating, such as aluminum or silver, or an alloy thereof.
3. A three-layer filter with minimal thickness and low reflectance and high transmissivity at a specified wavelength such as 650 nm, but still high reflectance at a different wavelength such as 405 nm.

The materials used in the following examples can be characterized by the following optical constants, measured by ellipsometry and reflection, transmission measurements of deposited single films of various thicknesses.

Silver Alloy

When used, the metallic silver layer preferably is a silver alloy instead of pure silver, due to the oxidation potential for silver exposed to ambient conditions. Most preferably, the silver alloy is an alloy of silver with another noble metal such as gold, palladium, platinum, osmium or iridium. The non-silver noble alloying metal can either be a single metal or a mixture of noble metals present in the alloy in a proportion of 0.1-10 percent, more preferably 2-10 percent, still more preferably 4-10 percent, and most preferably 6-10 percent. In addition to the noble alloying metal, additional alloying metal(s) or doping metals such as neodymium, zinc, copper, bismuth, etc. can be incorporated into the alloy in conventional amounts to impart desirable properties as known in the art. A specific alloy composition is made based on the intended application (i.e. wavelength(s) to be reflected/transmitted) to achieve desirable refractive properties at the necessary wavelengths. Criteria for the selection and composition of particular alloys to achieve desirable refractive properties at specific wavelengths are known in the art, and are described for example in U.S. Pats. Nos. 6,007,889 and 6,280,811, the contents of which are incorporated herein by reference.

For DVD production several silver alloys are routinely used which show good environmental stability and high reflectance. For example, the optical constants for a particular conventional alloy known as Kobelco GD02, a known AgNdCu alloy available from Kobelco Research Institute, Inc., were measured at 405 and 650 nm as follows:

n(405)=0.26, k(405)=1.8, n(650)=0.22, k(650)=3.9

As noted above, other alloys can be selected and produced by persons of ordinary skill in the art with different optical properties to meet specific requirements.

Dielectric Layer

The dielectric layer of the filter described herein preferably has a hydrogen-doped silicon composition, referred to herein Si:H. A Si:H dielectric layer can be produced by reactive sputtering of monocrystalline Si in an Ar—H₂ atmosphere using a UNAXIS Cube Light sputter system. As will be recognized, argon is the primary atmospheric component for the sputtering operation and provides a suitable inert atmosphere. Hydrogen is present in a small concentration relative to argon and is present so that it can be co-deposited onto the substrate as a dopant in the sputtered silicon layer. Typically, the atmosphere and dopant gases (Ar and H₂) are delivered to the sputter chamber at fixed flowrates relative to one another to obtain the desired concentration or partial pressure of each during sputtering. Suitable sputtering parameters for depositing a Si:H dielectric layer on a 12-cm diameter circular substrate, such as a conventional CD/DVD, are as follows:
sputter power 5 kW
sputter rate: 8.5 nm/sec
Ar flow: 30 sccm
H₂ flow: 12 sccm

Using these process parameters, Si:H dielectric layers have been produced having the following optical constants:

Ex. A: n(405)=3.62, k(405)=2.08, n(650)=3.60, k(650)=0.027

Ex. B: n(405)=4.11, k(405)=1.23, n(650)=3.27, k(650)=0.03

The hydrogen content of the films was varied by adjusting the influent H₂ flowrate until low absorption at the desired wavelengths (405 nm and 650 nm) was achieved through an iterative process. Although the precise Si:H stoichiometric ratio for these layers were not measured, the refractive index of the film at 650 nm typically varies between 3 and 3.6. The layers produced above, having the above-mentioned values for optical constants n and k at the specified wavelengths provide a good compromise of high refractive index and low absorption at the 650 nm wavelength. Also, while the above-noted layers were made using polycrystalline silicon, monocrystalline silicon works about as well to produce a Si:H layer because both have very similar optical constants.

The Si:H layers having the above optical constants are merely two examples of a Si:H layer that can be produced by a person of ordinary skill in the art based on the present disclosure, to obtain a layer having desirable constants and optical properties for a specific application. As will be appreciated, different layer compositions can be produced to exhibit optical constants that can be varied according to the detailed needs or production method. Also other materials may be used with a range of optical constants.

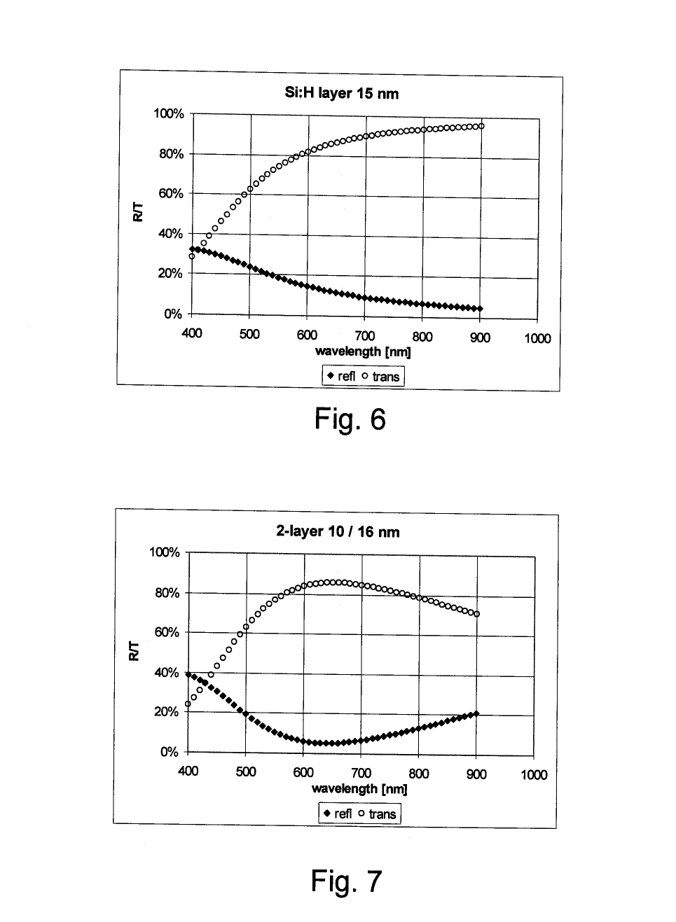

As already stated, the most economical design for a dichroic filter as described herein is a single dielectric layer, without a metallic layer. A suitable material for the single dielectric layer in this embodiment is Si:H as described above, in which case the Si:H layer can have a thickness of about 5 to 20 nm. FIG. 6 illustrates the calculated transmittance and reflectance spectra for a 15-nm thick Si:H layer within a bonded disc.

In addition to the silver alloy layer and Si:H layer mentioned above, the respective metallic and dielectric layers can be provided from different compositions. For example, the metallic layer can be another alloy or mixture of alloys, including copper and aluminum alloys. Preferably, when a copper or aluminum alloy is used, it is alloyed with a noble metal as mentioned above. Regarding the dielectric layer, other silicon compounds besides Si:H can be used. For example, the silicon can be provided or doped with other elements such as C, H, O and N in different amounts and in different combinations that may be useful. The hydrogen in the above-described Si:H dielectric layer has the effect of saturating dangling bonds in amorphous silicon structure, reducing absorption in the layer and, to some extent, also its refractive index. Other reactive elements such as those mentioned in this paragraph can be used to similar effect. One alternative dielectric composition that may be particularly useful is Si:Hₓ:C_{y}, which can be obtained by reactive sputtering of Si with hydrocarbons such as CH₄, C₂H₂ etc. Some care should be exercised when selecting other compositions besides Si:H. While other compositions such as those mentioned in this paragraph can be used in place of Si:H, in some instances they will be less desirable. For example, Si:Nₓ and Si:Oₓ compounds tend to exhibit higher absorption rates for a particular wavelength at the same refractive index compared to a Si:H layer. This makes them somewhat inferior to Si:H. In addition, depositing silicon layers doped with other elements such as C, O and N results in a lower deposition rate compared to depositing Si and H, which may make Si:H more preferred despite the low danger of explosion when using hydrogen (the danger is low due to the inert Ar atmosphere, and the relatively low H₂ partial pressures and flowrates used).

It has been found that a dichroic filter comprised of at least the metallic and dielectric layers above-described provides an effective information layer in a storage medium, capable to reflect at a first wavelength to read information stored in the dichroic filter layer, and to transmit at a second wavelength to permit reading information stored in a subjacent information layer. The dichroic filter so-constituted also can be provided as a thin layer, having a thickness of less than about 100 nm.

The invention will be better understood through reference to the following examples, which are provided by way of illustration and not limitation.

### EXAMPLE DESIGNS

Based on the dichroic filter architecture described herein, we devised several dual-layer optical storage medium designs that could be produced. For the following designs, as a substrate material we chose polycarbonate, with a refractive index of 1.57 at 650 nm. Typically, the filter is sandwiched between a polycarbonate substrate located adjacent the incident surface of the medium, and usually an intermediate (bonding) layer on the opposite side with a refractive index between 1.5 and 1.6. The intermediate layer is disposed in between and separates the dichroic filter (first information layer) from a subjacent (or second) information layer that is to be read at a different wavelength. For simplicity, we assume for the following proposed designs that the intermediate layer has the same index as polycarbonate. Also in the following designs, the metallic silver alloy layer, when used, is assumed to be a silver alloy with the optical constants as stated above. With the foregoing in mind, the following designs are proposed in accordance with the invention.

Single-Layer Dichroic Filter Example Based on Si:H

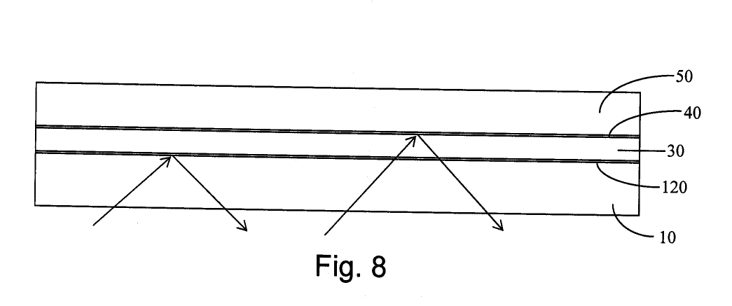

This design is intended for use in hybrid discs for dual wavelength use, for example 405 and 650 nm, and is illustrated in FIG. 8. The dicrhoic filter 120 in this embodiment is a single layer of Si:H; there is no metallic layer, such as a silver alloy layer, as part of the filter 120. As seen in FIG. 8, the read beam of light enters the polycarbonate substrate of the optical storage medium through the incident surface, on a trajectory toward the dichroic filter coated on the opposite surface of the substrate. For this example, the dichroic filter 120 is Si:H layer having an assumed thickness of approximately 15 nm. As illustrated in FIG. 8, the dichroic filter 120 is sandwiched in between the polycarbonate substrate 10 located adjacent the incident surface 5 of the medium, and an intermediate layer 30 on the opposite side. In actual production, the filter 120 (Si:H layer) may be coated as described above, on the substrate's information-carrying surface before bonding to the intermediate layer 30, or it may be coated on the intermediate layer 30 and then bonded to the first substrate 10, depending on the type of optical disc.

The present single-layer filter design (single Si:H layer having a thickness of 15 nm) for the first information layer, and a subjacent silver layer for the DVD reflecting layer, results in approximately 63% signal reflectance for the DVD signal (the light passing twice through the filter layer, with a reflection on the DVD layer including reflections from the incident surface of the disc. For the HD-DVD signal reflectance, one obtains around 30%. These values do not take into account signal losses caused by e.g. birefringence or production tolerances. The signal reflectance levels may be fine-tuned by adjusting the thicknesses of the layers. By reducing the thickness of the Si:H filter layer, reflection at 405 nm is reduced somewhat, while transmittance at 650 nm is increased, and therefore T², which is proportional to the resulting DVD signal. A DVD signal of about 65 to 70% is sufficient to be divided by a semireflective DVD layer into two signals of 18 to 32% signal reflectance for the design of a hybrid blue laser DVD9 dual layer disc.

The signal levels obtained by the proposed hybrid disc with the single-layer (Si:H layer, with no metallic layers) filter described here are superior to a previously proposed hybrid disc having a silver semireflective film for a first DVD layer and a HD-DVD fully reflective layer. The following table gives a calculation of the expected signal levels for both 16- and 10-nm Si:H layers. The 650 nm signal was calculated for a 95% silver reflector layer and 10% surface reflection losses.

| | | Signal | | Signal | |
|---|---|---|---|---|---|
| | First layer | 650 | Crosstalk650 | 405 | Crosstalk405 |
| inventive | HD DVD | 61% | 12% | 30% | 6% |
| design | blu-ray | 73% | 5% | 20% | 12% |
| semi- | DVD | 48% | 12% | 30%* | 22% |
| transparent | | | | | |
| silver layer | | | | | |

*assuming a silver reflection layer with 80% reflectance at 405 nm

Also shown in the table are signal levels for the 650 nm laser from the 405 nm information layer crosstalk (650) and for the 405 nm laser reflected from the DVD layer crosstalk (405). Also in this respect the inventive design is superior. These data are best understood with reference to FIG. 5, wherein the signal 650 beam is illustrated at 204, based on an incident 650 beam at 200 with 405 crosstalk at 202, an the signal 405 beam is illustrated at 104, based on an incident 405 beam at 100 with 650 crosstalk at 102.

In FIG. 9, the dependence of signal levels is shown as a function of layer thickness based on single Si:H layer filter, with no metallic layer. The specifications are met by a range of thicknesses from 9 to 15 nm, the exact range depending on material parameters and the reflectivity of the fully reflective DVD layer. The signal levels are well within the required range and allow for signal losses which have not been included such as birefringence and diffraction effects.

Two-Layer Dichroic Filter Example Based on Silver Alloy and Si:H

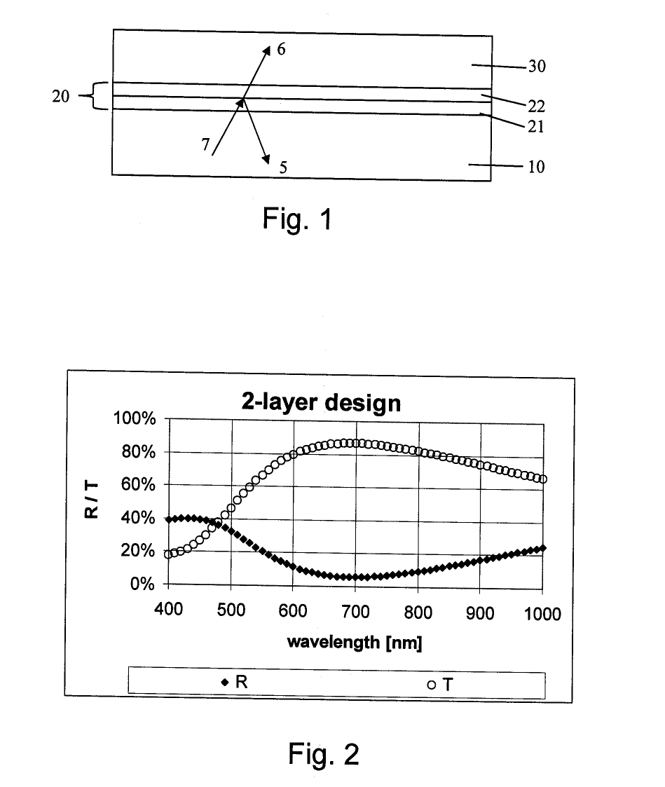

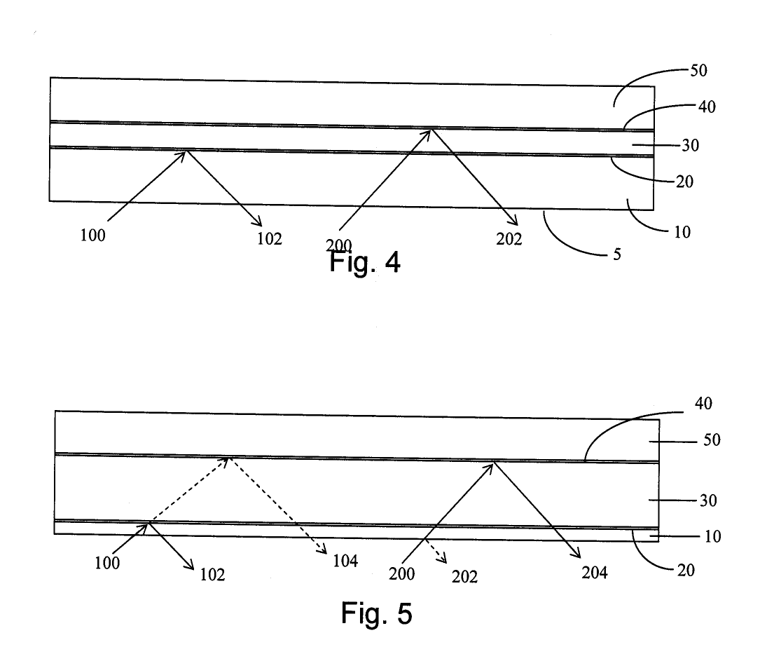

This design is intended for use in hybrid discs for dual wavelength use at 405 and 650 nm (FIG. 4). The two-layer design of the dichroic filter 20 is illustrated in FIG. 1. The read beam of light enters the polycarbonate substrate of the optical storage medium through the incident surface, on a trajectory toward the dichroic filter coated on the opposite surface of the substrate. For this example, the dichroic filter 20 is a two-layer structure including a silver alloy metallic layer (layer 21 illustrated in FIG. 1) having an assumed thickness of approximately 10 nm, and a Si:H dielectric layer (layer 22 illustrated in FIG. 1) having an assumed thickness of approximately 16 nm. As illustrated in FIG. 4, the laminate dichroic filter 20 is sandwiched in between the polycarbonate substrate 10 located adjacent the incident surface 5 of the medium, and an intermediate layer 30 on the opposite side. In the illustrated embodiment, the metallic layer (layer 21 in FIG. 1, not separately illustrated in FIG. 4) of the filter 20 is provided adjacent the polycarbonate substrate 10, with the dielectric layer (layer 22 in FIG. 1) disposed behind it. In actual production, the filter 20 may be coated as described or in the reverse order, starting with the intermediate layer 30, coating that layer with Si:H and silver and bonding it to the first substrate 10 in that order, depending on the type of optical disc.

For simplicity we disregard reflections from the incident surface 5 of the substrate 10 and from the intermediate layer 30, and consider only the transmission and reflection of the filter 20 itself. Calculated data for reflection and transmission for the filter 20 are provided in FIG. 2. Remarkable is the high transmittance of this filter at 650 nm (calculated as 86% based on the optical constants noted above), which is higher than the transmittance of a single silver layer (73%) or Si:H layer (84%) of the same thickness as used in the combination. At the same time, the filter has a reflectance at 405 nm calculated as about 40%. Hence, the filter in this example will have both high transmittance at 650 nm and high reflectance at 405 nm, yet it will be only about 26 nm thick.

Three-Layer Dichroic Filter Example Based on Silver Alloy and Si:H, AR Coating for 650 nm

With the addition of an additional silver alloy layer between the Si:H layer and the intermediate layer, an antireflective filter 20 for a specified wavelength may be designed, again with very low thicknesses. In this example, the following thicknesses are used:

7.5 nm for both silver alloy layers,

21 nm for the Si:H layer between the silver alloy layers.

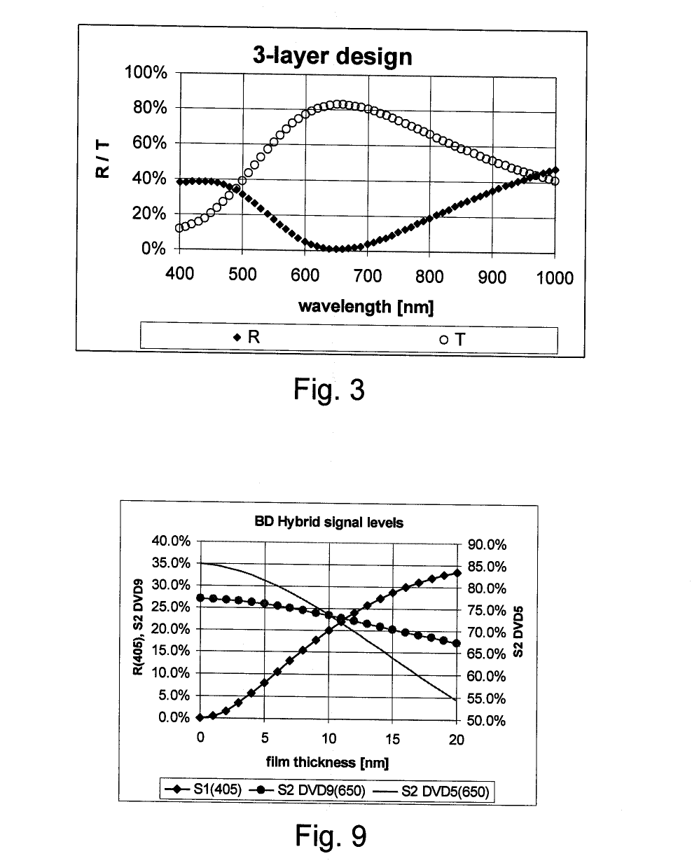

Calculated reflectance and transmittance data for this example are shown in the graph of FIG. 3. For this embodiment, calculated reflectance at 405 nm is similar to the two information layer example mentioned above. Transmittance at 650 nm is also close to the two information layer design. It would be considerably higher for pure silver films, which however are of small practical value because of their low environmental stability compared to silver alloys as used for DVD9 optical discs. This filter resembles somewhat a conventional Fabry-Perot filter, with two mirrors separated by a spacer layer. However it differs from a conventional Fabry-Perot filter in the shorter thickness, the complete filter being thinner (36 nm total thickness) than a short Fabry-Perot with nominal length of N*lambda/2/n, N being an integer and n the refractive index of the spacer (N*89 nm).

For Comparison: Three-Layer Dichroic Filter Example Based on Silver Alloy and Si:N (n=2.0 @ 650 nm), Instead of Si:H

Reducing the refractive index of the intermediate (dielectric) layer requires an increase of the layer thickness. With a refractive index n=2.0 for this layer and the same silver alloy layers, a layer thickness of 85 nm is required or a total thickness of 100 nm, 2.7 times higher than in the previous example. This shows the importance of a high refractive index of the dielectric layer for small total thickness and therefore economic production.

Detailed Description of the Applications to Hybrid Discs, with Information Layers with Readout at 405 and 650 nm.

As one application, we show the use of the filter 20,120 as a reflective layer for blue laser discs at 405 nm wavelength readout of the stored information, which also allows the readout of a second information layer 40 (see FIG. 5) for a red laser at 650 nm according to the DVD specifications.

The sequence of substrates and films is as follows in the order of the laser beam entering into the disc from the incident surface 5 (FIGS. 4, 5 and 8):
substrate 10 (0.1 mm for blu-ray disc, 0.6 mm for HD-DVD)
dichroic filter 20,120 embodying the invention—silver alloy and Si:H layers (filter 20) in the case of FIGS. 4-5, and Si:H layer alone, with no metallic layer (filter 120) in the case of FIG. 8), reflecting at 405 nm
intermediate layer 30 (0.5 mm for blu-ray disc, 30 to 50 μm for HD-DVD)
reflective DVD layer or second information layer 40 (reflecting at 650 nm)
substrate 50 (0.6 mm)

In addition to the illustrated embodiments in FIGS. 4-5 and 8, another semireflective DVD layer followed by another intermediate (bonding) layer may be inserted in front of the last reflective layer, doubling the data capacity of the DVD layer to 9 GB as in a DVD9.

There are several production methods according to the type of the disc, which are well known and similar to the production of DVD9 discs or blu-ray discs. A simple example is the production of a HD-DVD single layer combined with a DVD5 single layer. In this case a first substrate that is already provided with a pattern of pits and grooves corresponding with the HD-DVD information to be recorded on one surface is provided with a dichroic filter layer as described herein. In the case of a single dielectric layer such as Si:H, where no metallic layer will be used, the Si:H layer is coated onto the surface of the substrate containing the HD-DVD information pit-and-groove pattern. In the case of a two-layer laminate filter structure, e.g. having both one dielectric layer and one metallic layer, the information-carrying surface of the substrate can be coated with a silver alloy layer followed by a Si:H layer to provide a laminate dichroic filter as described herein. In either case, the coated substrate is then bonded to a second substrate whose surface is provided with DVD information pits and coated with a silver or aluminum layer, so that the intermediate (bonding) layer in between the respective substrates forms a spacer of approx. 20 to 50 μm thickness between the information layers.

In the case of a blu-ray DVD hybrid disc, a 0.5 mm blu-ray substrate is coated with a Si:H layer and, if desired, a silver layer, and then covered with a 100 μm cover layer (substrate 10 in FIG. 5) made by spin coating or bonding a thin foil. This half disc is bonded on the back side with a DVD substrate having a reflective coating.

In the case of a three information layer system, the reflective second substrate is replaced by a double layer substrate that can be made in a similar way as double layers used for DVD14/18. Namely, the second substrate is coated with a reflective film, a second information layer may be added e.g. with a 2P process, which is coated with a semireflective film and finally bonded to the first substrate. In a disk of the blu-ray type, the second DVD layer may also be formed on the backside of the 0.5 mm substrate. This requires a molding process with a blu-ray stamper on one side and a DVD stamper on the other side, but simplifies the overall production process.

One goal of the invention is to produce a disc that fully conforms to both blue laser disc specifications and DVD specifications. The DVD specifications are finalized and easily met by the present design. The main aspects of the HD-DVD and blu ray specifications are also known but have not been finalized. Specifically:
DVD reflectivity should be 60 to 85% for single layer, 18 to 32% for dual layer
HD-DVD reflectivity is 18-32% for hybrid or dual layer
Blu-ray reflectivity at 405 nm should be 12-28% for the hybrid disc

The invention is not limited to data storage media or applications. The basic dichroic filter laminate film design is useful for other applications where thickness of the film system or production cost is important, such as long wavelength pass filters applied to sensors, color splitting devices.

The small layer thickness for filters described herein are particularly useful for coating nonplanar surfaces such as gratings, Fresnel plates, where problems with step coverage or unwanted diffraction effects occur.

A further advantage of the proposed film systems is the low angle and polarization sensitivity, making them useful for color separating beam splitters at non-normal incidence (e.g. 45°). This has not yet been fully explored (see FIG. 6).

One advantage in multi-layer filter designs described herein, such as a Si:H-silver alloy laminate structure, is the small sensitivity of transmittance and reflectance to thickness and index variations comparable to single films, which makes it easier to achieve high production yield in optical disc production.

Although the invention has been described with respect to certain preferred embodiments, the invention is not to be limited to the embodiments described, and numerous modifications or alterations can be made thereto by persons of ordinary skill in the art based on the present disclosure without departing from the spirit and the scope of the invention as set forth in the appended claims.

What is claimed is:

1. An optical storage medium comprising a first information layer and a second information layer, said first and second information layers being spaced apart from one another by an intermediate layer, said first information layer being reflective of light at a first selected wavelength and transmissive of light at a second selected wavelength, said second information layer being reflective of light at said second selected wavelength, said first information layer being provided as a dichroic filter having at least one dielectric layer but excluding metallic layers, wherein the total thickness of said dichroic filter is about or less than 100 nm.

2. An optical storage medium according to claim 1, said dichroic filter being sandwiched between a substrate on one side and said intermediate layer on the other side, said substrate defining an incident surface of said optical storage medium that is spaced from said dichroic filter.

3. An optical storage medium according to claim 1, said substrate being polycarbonate.

4. An optical storage medium according to claim 1, said dielectric layer being a silicon-based layer having a refractive index greater than 2.0.

5. An optical storage medium according to claim 4, said silicon-based layer comprising silicon doped with an atomic dopant selected from the group consisting of H, O, C and N.

6. An optical storage medium according to claim 4, said silicon-based layer being a Si:H layer.

7. An optical storage medium according to claim 4, said dielectric layer having a thickness of 5-30 nm.

8. An optical storage medium according to claim 4, said dielectric layer having a thickness of 5-20 nm.

9. An optical storage medium according to claim 4, said dielectric layer having a thickness of 10-20 nm.

10. An optical storage medium according to claim 1, said dichroic filter having a total thickness about or less than 60 nm.

11. An optical storage medium according to claim 1, said dichroic filter being highly reflective of light at said first selected wavelength, and highly transmissive of light at said second selected wavelength.

12. An optical storage medium according to claim 1, said second selected wavelength of light being 405 nm, and said storage medium exhibiting a signal reflectance of at least 18% for said second selected wavelength.

13. An optical storage medium according to claim 1, said second selected wavelength of light being 405 nm, and said storage medium exhibiting a signal reflectance of at least 30% for said second selected wavelength.

14. A method of making an optical storage medium comprising:
a) providing a support layer having a first surface; and
b) providing on said first surface a first information layer in the form of a dichroic filter that comprises a dielectric layer but no metallic layers, said dichroic filter having a total thickness of about or less than 100 nm, wherein a composition of said dielectric layer is selected so that said dichroic filter is reflective of light at a first selected wavelength, and transmissive of light at a second selected wavelength.

15. A method according to claim 14, said support layer being a substrate that defines an incident surface for said optical storage medium located opposite said first surface.

16. A method according to claim 15, said dichroic filter being provided by depositing said dielectric layer on said first surface of said substrate.

17. A method according to claim 16, further comprising the steps of:
c) bonding an intermediate layer to said dielectric layer so that said dichroic filter is sandwiched between said substrate and said intermediate layer;
d) depositing a second information layer on said intermediate layer; and
e) bonding a backing layer to said second information layer.

18. A method according to claim 14, said dielectric layer being a Si:H layer.

19. A method according to claim 14, said support layer being an intermediate layer for separating said first information layer from a second information layer.

20. A method according to claim 19, said dichroic filter being provided by depositing said dielectric layer on said first surface of said intermediate layer, said method further comprising bonding a substrate to said dielectric layer, opposite said intermediate layer, layer so that said dichroic filter is sandwiched between said intermediate layer and said substrate.

21. An optical storage medium comprising a first information layer and a second information layer, said first and second information layers being spaced apart from one another by an intermediate layer, said first information layer being reflective of light at a first selected wavelength and transmissive of light at a second selected wavelength, said second information layer being reflective of light at said second selected wavelength, said first information layer being provided as a dichroic filter comprising a dielectric layer, wherein the total thickness of said dichroic filter is about or less than 100 nm.
